(19) United States
(12) Patent Application Publication
(10) Pub. No.: US 2016/0041540 A1
(43) Pub. Date: Feb. 11, 2016

(54) HOME CONTROLLER AND INFORMATION UPDATING METHOD THEREOF

(71) Applicant: proeasy network solutions co., LTD., Hsinchu County (TW)

(72) Inventor: Hsing-Hung Lu, Hsinchu County (TW)

(21) Appl. No.: 14/521,459

(22) Filed: Oct. 22, 2014

(30) Foreign Application Priority Data
Aug. 11, 2014 (TW) 103127479

(51) Int. Cl. G05B 15/02; H04L 12/28; G06F 9/445

(52) U.S. Cl. CPC G05B 15/02; G06F 8/65; H04L 12/2803

(57) ABSTRACT

A home controller and an information updating method thereof are provided. The home controller is configured to control a home equipment and includes a micro-processing unit, a first fiber interface circuit, a second fiber interface circuit and a first button. The first button is coupled to the micro-processing unit and disposed on a shell body of the home controller. If the first button is triggered, the micro-processing unit receives identifier (ID) information through the first fiber interface circuit or the second fiber interface circuit and updates the ID of the home controller according to the ID information.

### CROSS-REFERENCE TO RELATED APPLICATION

This application claims the priority benefit of Taiwan application serial no. 103127479, filed on Aug. 11, 2014. The entirety of the above-mentioned patent application is hereby incorporated by reference herein and made a part of this specification.

### BACKGROUND OF THE INVENTION

1. Field of the Invention

The invention relates to a home control technology, and particularly relates to a home controller and an information updating method thereof.

2. Description of Related Art

Since nearly half a century, the development in the field of computers has been prosperous. The advanced technology in this field allows many automated equipments, such as washing machines, dish washers, and sweeping robots, to be introduced to our daily life. In addition, since the household population structure as well as the work style in the modern society has been changed, the manual labor devoted to household chores has been gradually replaced by machines. Meanwhile, integrated solutions aiming at coordinating, managing, and controlling various home appliances or equipments such as luminaires, TVs, security systems, air-conditioners, audiovisual systems now constantly hit the market. Novel terms such as “Smart Home”, “digital home”, “Electronic Home”, “Home Automation” also emerge one after another.

To set up a home control system, a certain number of home controllers need to be disposed at home. Each home controller is configured to control one or more corresponding home equipments. Therefore, how to allow the user to conveniently update or maintain important information in each home controller is certainly an issue for researchers in this field to work on.

### SUMMARY OF THE INVENTION

The invention provides a home controller and an information updating method thereof allowing the user to conveniently update or maintain important information in each home controller.

In an exemplary embodiment of the invention, a home controller is provided. The home controller is configured to control a home equipment and includes a micro-processing unit, a first fiber interface circuit, a second fiber interface circuit, and a first button. The first fiber interface circuit is coupled to the micro-processing unit. The second fiber interface circuit is coupled to the micro-processing unit. The first button is coupled to the micro-processing unit and disposed on a shell body of the home controller. If the first button is triggered, the micro-processing unit receives identifier information through the first fiber interface circuit or the second fiber interface circuit and updates an identifier of the home controller based on the identifier information.

According to an exemplary embodiment of the invention, the home controller further includes a second button. The second button is coupled to the micro-processing unit and disposed on the shell body of the home controller. If the second button is triggered, the micro-processing unit receives firmware information through the first fiber interface circuit or the second fiber interface circuit and updates a firmware of the home controller based on the firmware information.

According to an exemplary embodiment of the invention, the home controller further includes a third button. The third button is coupled to the micro-processing unit and disposed on the shell body of the home controller. In addition, the micro-processing unit enables or disables the first button based on whether the third button is triggered.

According to an exemplary embodiment of the invention, the home controller further includes a wireless communication circuit. The wireless communication circuit is configured to transmit a control command including the identifier, wherein the control command serves to control the home equipment.

According to an exemplary embodiment of the invention, the identifier information is assigned by the home controller.

According to an exemplary embodiment of the invention, the home controller further includes a buck circuit, wherein the buck circuit does not include a voltage converter.

An exemplary embodiment of the invention also provides an information updating method of a home controller, wherein the home controller is configured to control at least one home equipment, and the information updating method of the home controller includes: detecting whether a first button on a shell body of the home controller is triggered; if the first button is triggered, receiving identifier information through a first fiber interface circuit of the home controller or a second fiber interface circuit of the home controller; and updating an identifier of the home controller based on the identifier information.

According to an exemplary embodiment of the invention, the information updating method of the home controller further includes: detecting whether a second button on the shell body of the home controller is triggered; if the second button is triggered, receiving firmware information through the first fiber interface circuit or the second fiber interface circuit; and updating a firmware of the home controller based on the firmware information.

According to an exemplary embodiment of the invention, the information updating method further includes: detecting whether a third button on the shell body of the home controller is triggered; and enabling or disabling the first button based on whether the third button is triggered.

According to an exemplary embodiment of the invention, the information updating method of the home controller further includes: transmitting a control command including the identifier, wherein the control command serves to control the home equipment.

Based on the above, by triggering a specific button at the external part of the home controller, the user is allowed to conveniently update information of the home controller such as the identifier of the home controller. Therefore, a complicated operating procedure is not required.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a home control system according to an exemplary embodiment of the invention.

FIGS. 2 and 3 are schematic views illustrating a home controller according to an exemplary embodiment of the invention.

FIG. 4 is a schematic view illustrating a home controller according to another exemplary embodiment of the invention.

FIG. 5 is a diagram illustrating an information updating method of a home controller according to an exemplary embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

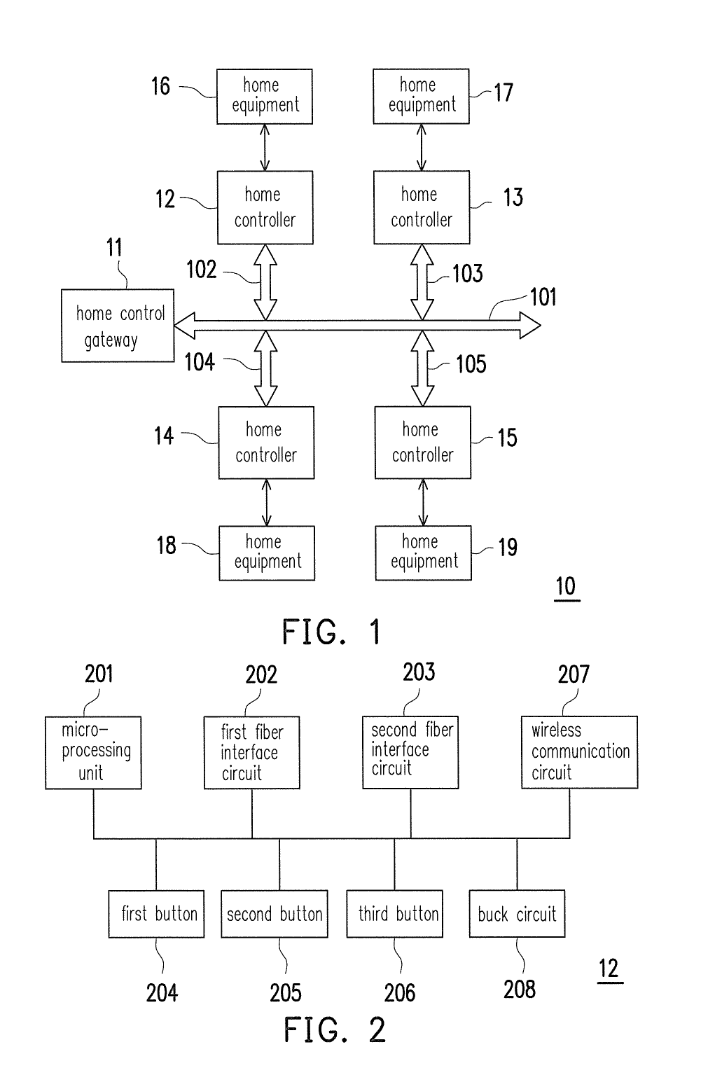

FIG. 1 is a schematic view illustrating a home control system according to an exemplary embodiment of the invention.

Referring to FIG. 1, a home control system 10 includes a home control gateway 11, home controllers 12 to 15, and home equipments 16-19.

The home control gateway 11 is a primary control device of the home control system 10. For example, the home control gateway 11 may receive a user operation in a wired or wireless manner and proceed to control, maintain, and manage the home controllers 12-15 based on the user operation.

In this exemplary embodiment, each of the home controllers 12-15 is configured to control one of the home equipments 16-19. For example, the home controller 12 is configured to control the home equipment 16, the home controller 13 is configured to control the home equipment 17, the home controller 14 is configured to control the home equipment 18, and the home controller 15 is configured to control the home equipment 19. Each of the home controllers 12-15 transmits a control command to the corresponding one of the home equipments 16-19 to control the corresponding one of the home equipments 16-19 to perform a corresponding operation. In another exemplary embodiment, one home controller may also be configured to control a plurality of home equipments, or one home equipment may be controlled by a plurality of home controllers.

Each of the home equipments 16-19 may be a power equipment, an illumination equipment, a security equipment, an air-conditioning equipment, or an audiovisual entertainment equipment. However, the types of the home equipments 16-19 are not limited thereto. In this exemplary embodiment, each of the home equipments 16-19 has at least one micro-processor unit (not shown), a control circuit (not shown), or a control chip (not shown) to perform a corresponding operation based on the control command provided by one of the home controllers 12-15. For example, if the home equipment 16 is an illumination equipment, the home equipment 16 may be turned on/off correspondingly based on the control command provided by the home controller 12. If the home equipment 17 is an audiovisual entertainment equipment, the home equipment 17 may correspondingly perform operations such as playing, pausing, rewinding, and forwarding a multimedia file based on the control command provided by the home controller 13. In this exemplary embodiment, the home controllers 12-15 may transmit the control commands to the home equipments 16-19 in a wired or wireless manner, and the home equipments 16-19 may also transmit equipment information to the home controllers 12-15 in a wired or wireless manner.

In an exemplary embodiment, each of the home controllers 12-15 is suitable to be configured beside a power receptacle (not shown) to be used with a power line. Besides, in an exemplary embodiment, the home controllers 12-15 may also be individually disposed at arbitrary positions or in the home equipments 16-19. The invention is not limited thereto. In an exemplary embodiment of the invention, the numbers of the home control gateway 11, home controllers 12-15, and home equipments 16-19 may be more or less. The invention is not limited thereto.

In this exemplary embodiment, the home control gateway 11 is coupled to the home controllers 12-15 through fibers 101 to 105. The invention does not limit types and materials of the fibers 101 to 105. For example, the fibers 101 to 105 may include single-mode fibers or multi-mode fibers, and the invention is not limited thereto. In an exemplary embodiment, the fibers 101-105 may also be used with or replaced by a power line. For example, in an exemplary embodiment, some wires close to the home control gateway 11 are power lines, while some wires close to the home controllers 12-15 are fibers. Alternatively, in an exemplary embodiment, the fibers 101-103 are replaced by power lines, and the fibers 104 to 105 remain to be fibers. The invention is not limited thereto.

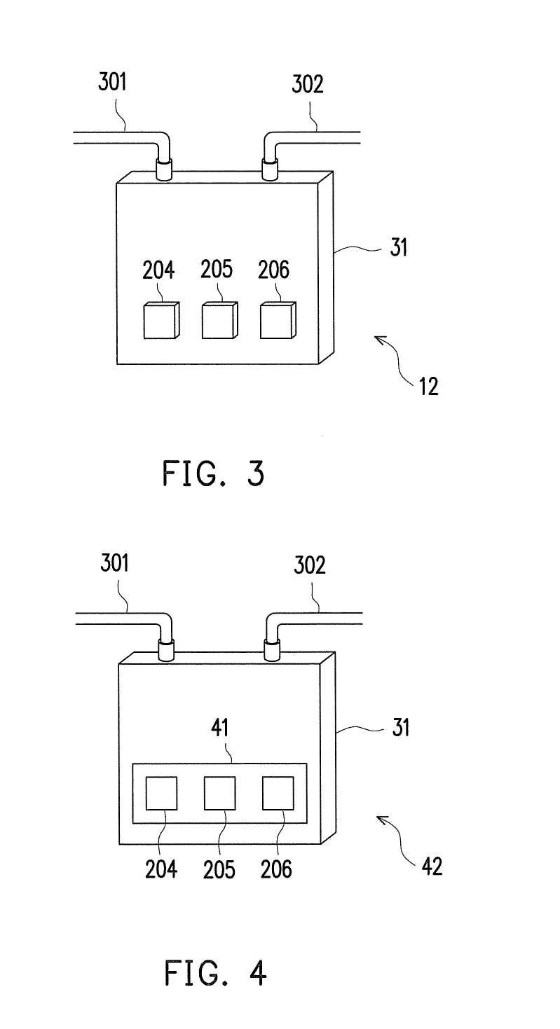

FIGS. 2 and 3 are schematic views illustrating a home controller according to an exemplary embodiment of the invention.

Referring to FIGS. 2 and 3 and taking the home controller 12 as an example, the home controller 12 in this embodiment includes a micro-processing unit 210, a first fiber interface circuit 202, a second fiber interface circuit 203, a first button 204, and a shell body 31.

The micro-processing unit 201 is a hardware, having a computing capability, such as a chipset or a processor, to control an overall operation of the home controller 12. In this exemplary embodiment, the micro-processing unit 202 is a central processing unit (CPU) or other programmable microprocessor, digital signal processor (DSP), programmable controller, application specific integrated circuit (ASIC), programmable logic device, or other similar devices, for example.

The first fiber interface circuit 202 and the second fiber interface circuit 203 are configured to be coupled to the fiber 102. For example, the first fiber interface circuit 202 and the second fiber interface circuit 203 respectively include a fiber connector. As shown in FIG. 3, the first fiber interface circuit 202 is coupled to one end of a fiber 301, and the second fiber interface circuit 203 is coupled to one end of a fiber 302. The fibers 301 and 302 are part of the fiber 102. In addition, the first fiber interface circuit 202 and the second fiber interface circuit 203 are also coupled to the micro-processing unit 201 to transmit data from the micro-processing unit 201 to the fiber 102 or transmit data from the fiber 102 to the micro-processing unit 201.

The first button 204 is disposed on the shell body 31. In addition, the shell body 31 covers part or all of the electronic elements of the home controller 12. Besides, the first button 204 is also coupled to the micro-processing unit 201. If the first button 204 is triggered, the micro-processing unit 201 receives identifier (ID) information from the first fiber interface circuit 202 or the second fiber interface circuit 203 and updates an identifier of the home controller 12 based on the identifier information. After the identifier is updated, the updated identifier is stored in the micro-processing unit 201 and managed by the micro-processing unit 201.

Specifically, the home control gateway 11 is responsible for managing and assigning the identifier of each of the home controllers 12-15. However, the invention does not limit a format of the identifier. In an exemplary embodiment, the home control gateway 11 generates the identifier information associated with the identifier of each of the home controllers 12-15 and transmits the identifier information to the fiber 101. In this way, after the first button 204 of the home controller 12 is triggered, the home controller 12 receives the corresponding identifier information. Besides, in another exemplary embodiment, if the first button 204 is triggered, the micro-processing unit 201 transmits a validation code updating message to the home control gateway 11 through the first fiber interface circuit 202 or the second fiber interface circuit 203. If the home control gateway 11 receives the validation code updating message, the home control gateway 11 then generates the identifier information corresponding to the home controller 12 based on the validation code updating message and transmits the identifier information to the fiber 101.

In this exemplary embodiment, the micro-processing unit 201 continuously detects whether the first button 204 is triggered. For example, conditions that the first button 204 is triggered include the first button 204 being rapidly pressed, the first button 204 being pressed for over a first predetermined time (e.g. 2 seconds), or the first button 204 being pressed for more than a predetermined number of times within a second predetermined time. However, the invention is not limited thereto.

In an exemplary embodiment, the home controllers 12-15 are set up in a token-ring configuration. Taking the home controller 12 as an example, if the first fiber interface circuit 202 is a fiber signal input end of the home controller 12 and the second fiber interface circuit 203 is a fiber signal output end of the home controller 12, the other end of the fiber 301 is serially connected to a fiber signal output end of the previous home controller (e.g. the home controller 13), and the other end of the fiber 302 is serially connected to a fiber signal input end of the next home controller (e.g. the home controller 14), and so on so forth. In this way, if only the first button 204 is pressed, only the home controller 12 receives the identifier information transmitted through the fiber 101, while the home controllers 13-15 do not receive the identifier information transmitted through the fiber 101. Thus, procedures for assigning and setting the identifiers of the home controllers are significantly simplified. Also, in another exemplary embodiment, the home controllers 12-15 may be set up in an arbitrary way, and the invention is not limited thereto.

In another exemplary embodiment, the identifier information transmitted through the fiber 101 may also include a simple validation message (e.g. IP address or MAC address, etc.). Here, the validation message serves to indicate the home controller whose identifier needs to be updated. For example, if the validation message in identifier information indicates that the identifier of the home controller 13 needs to be updated, then only the home controller 13 receives the identifier information and updates the identifier thereof accordingly.

Referring to FIGS. 2 and 3 again, in an exemplary embodiment, the home controller 12 further includes a second button 205 and/or a third button 206. The second button 205 and the third button 206 may be optionally disposed.

The second button 205 and the third button 206 are coupled to the micro-processing unit 201 and disposed on the shell body 31. If the second button 205 is triggered, the micro-processing unit 201 receives firmware information through the first fiber interface circuit 202 or the second fiber interface circuit 203 and updates a firmware of the home controller 12 based on the firmware information. The firmware of the home controller 12 includes a firmware required for operating an arbitrary electronic element in the micro-processing unit 201 and/or the home controller 12. Similar to the identifier information, the firmware information is also managed and assigned by the home control gateway 11. For example, the home controller gateway 11 may retrieve the firmware information of the home controller 12 through the Internet or by using any possible way and transmit the firmware information to the fiber 101. After the second button 205 of the home controller 12 is triggered, the home controller 12 is allowed to receive the corresponding firmware information. In another exemplary embodiment, if the second button 205 is triggered, the micro-processing unit 201 transmits a firmware updating message to the home control gateway 11 through the first fiber interface circuit 202 or the second fiber interface circuit 203. If the home control gateway 11 receives the firmware updating message, the home control gateway 11 then checks whether the firmware of the home controller 12 needs to be updated based on the firmware updating message. If the firmware of the home controller 12 needs to be updated, the home control gateway 11 then transmits the firmware information corresponding to the home controller 12 to the fiber 101. If the firmware of the home controller 12 does not need to be updated, the home control gateway 11 may choose to transmit or not transmit the corresponding firmware information.

The third button 206 is configured to enable or disable the first button 204 and/or the second button 205. In other words, the micro-processing unit 201 determines whether to enable or disable the first button 204 and/or the second button 205 based on whether the third button 206 is triggered. In an exemplary embodiment, the first button 204 and the second button 205 are triggered only after being enabled. If the first button 204 or the second button 205 is disabled, the disabled first button 204 or the disabled second button 205 is unable to be triggered. In an exemplary embodiment, if the third button 206 is triggered, the first button 204 and the second button 205 are enabled at the same time. Alternatively, in an exemplary embodiment, if the third button 206 is triggered, one of the first button 204 and the second button 205 is enabled. It is possible the first and second buttons 204 and 205 are enabled at the same time, the first and second buttons 204 and 205 are disabled at the same time, the second button 205 is enabled when the first button 204 is disabled, or the second button 205 is disabled when the first button 204 is enabled. The invention is not limited thereto. Besides, ways of triggering the second button 205 and the third button 206 are the same as or similar to the way of triggering the first button 204, so further details in this respect will not be reiterated below. In particular, enabling or disabling the first button 204 and/or the second button 205 by the third button 206 may be implemented as hardware or software. For example, if it is implemented as hardware, a circuit switch may be used. Alternatively, if it is implemented as software, a predetermined rule may be used to determine whether to ignore a triggering signal from the first button 204 and/or the second button 205. The invention does not limit the way that the first button 204 and/or the second button 205 is enabled or disabled.

It should be noted that in the exemplary amendment shown in FIG. 3, physical buttons are used as an example of the first, second, and third buttons 204, 205, and 206. However, in another exemplary embodiment, the first, second, and third buttons 204, 205, and 206 may also be virtual buttons.

FIG. 4 is a schematic view illustrating a home controller according to another exemplary embodiment of the invention.

Referring to FIG. 4, a home controller 42 differs from the home controller 12 in FIG. 3 in that a screen 41 is disposed on the home controller 42. In this exemplary embodiment, the screen 41 is a touch screen. On the screen 41, at least one of the first button 204, the second button 205, and the third button 206 is displayed. The user may trigger at least one of the first button 204, the second button 205, and the third button 206 by touching the screen 41. In an exemplary embodiment, if the screen 41 is not a touch screen, the user may use a remote controller or a mobile device to choose a button on the screen 41 to trigger.

Referring to FIG. 2 again, in an exemplary embodiment, the home controller 12 further includes a wireless communication circuit 207. The wireless communication circuit 207 is coupled to the micro-processing unit 201 and is configured to transmit a control command including the identifier of the home controller 12 in a wireless manner. In addition, the control command serves to control the home equipment controlled by the home controller 12. For example, if the home controller 12 controls the home equipment 16, the micro-processing unit 201 may transmit the control command including the identifier of the home controller 12 to the home equipment 16 through the wireless communication circuit 207, so as to control the home equipment 16 to perform a corresponding operation. In addition, in an exemplary embodiment, if the home equipment 16 needs to transmit equipment information to the home controller 12, the equipment information also includes the identifier of the home controller 12. In this exemplary embodiment, the wireless communication circuit 207 is capable of supporting one of the global system for mobile communication (GSM), the personal handy-phone system (PHS), the code division multiple access (CDMA) system, the wireless fidelity (WiFi) system, the worldwide interoperability for microwave access (WiMAX) system, the third generation wireless communication technology (3G), the long term evolution (LTE) technology, and the infrared transmission, or a combination thereof. However, the invention is not limited thereto.

Referring to FIG. 2 again, in an exemplary embodiment, the home controller 12 further includes a buck circuit 208. The buck circuit 208 is configured to receive a voltage from supply mains or from a battery. The buck circuit 208 is coupled to the micro-processing unit 201 and is configured to lower a voltage input to an arbitrary electronic element in the micro-processing unit 201 and/or the home controller 12. In addition, the buck circuit 208 does not include any voltage converter. Consequently, a size of the home controller 12 may be reduced. For example, the buck circuit 208 may include one or more electronic elements suitable for lowering a voltage, such as resistors or diodes. In an exemplary embodiment, none of the home controllers 12-15 includes a voltage converter.

It should be noted that the description about the home controller 12 also applies to the home controllers 13-15.

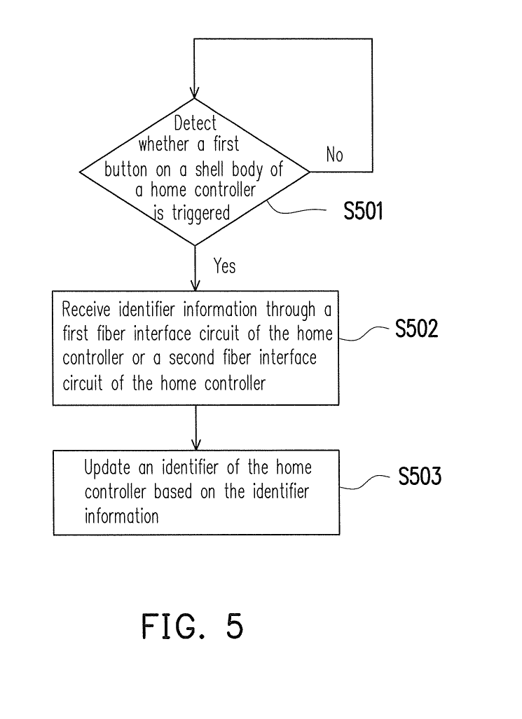

FIG. 5 is a diagram illustrating an information updating method of a home controller according to an exemplary embodiment of the invention.

Referring to FIG. 5, at Step S501, whether a first button on an shell body of the home controller is triggered is detected. If the first button is not triggered, Step S501 is repeated. If the first button is triggered, then, at Step 502, identifier information is received through a first fiber interface circuit of the home controller or a second fiber interface circuit of the home controller. At Step 503, an identifier of the home controller is updated based on the identifier information.

Details with respect to the steps shown in FIG. 5 are described above. Therefore, no further details in this respect will be reiterated below. It should be noted that the steps in FIG. 5 may be implemented in the form a plurality of program codes or circuits. The invention is not limited thereto. Also, the method shown in FIG. 5 may be used with the exemplary embodiments described above or be used separately. The invention is not limited thereto.

In view of the foregoing, by triggering a specific button at the external part of the home controller, the user is allowed to conveniently update information of the home controller such as the identifier of the home controller. Therefore, a complicated operating procedure is not required. In addition, since the fibers are used to transmit information and no voltage converter is disposed in the home controller, the anti-interference capability of the transmitted information is improved, and the size of the home controller is effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A home controller, configured to control at least one home equipment, comprising:
a micro-processing unit;
a first fiber interface circuit, coupled to the micro-processing unit;
a second fiber interface circuit, coupled to the micro-processing unit; and
a first button, coupled to the micro-processing unit and disposed on a shell body of the home controller,
wherein if the first button is triggered, the micro-processing unit receives identifier information through the first fiber interface circuit or the second fiber interface circuit and updates an identifier of the home controller based on the identifier information.

2. The home controller as claimed in claim 1, further comprising:
a second button, coupled to the micro-processing unit and disposed on the shell body of the home controller,
wherein if the second button is triggered, the micro-processing unit receives firmware information through the first fiber interface circuit or the second fiber interface circuit and updates a firmware of the home controller based on the firmware information.

3. The home controller as claimed in claim 1, further comprising:
a third button, coupled to the micro-processing unit and disposed on the shell body of the home controller,
wherein the micro-processing unit enables or disables the first button based on whether the third button is triggered.

4. The home controller as claimed in claim 1, further comprising:
a wireless communication circuit, configured to transmit a control command comprising the identifier, wherein the control command serves to control the at least one home equipment.

5. The home controller as claimed in claim 1, wherein the identifier information is assigned by a home control gateway.

6. The home controller as claimed in claim 1, further comprising:
a buck circuit, wherein the buck circuit does not comprise a voltage converter.

7. An information updating method of a home controller, wherein the home controller is configured to control at least one home equipment, the information updating method of the home controller comprising:
detecting whether a first button on a shell body of the home controller is triggered;
if the first button is triggered, receiving identifier information through a first fiber interface circuit of the home controller or a second fiber interface circuit of the home controller; and
updating an identifier of the home controller based on the identifier information.

8. The information updating method of the home controller as claimed in claim 7, further comprising:
detecting whether a second button on the shell body of the home controller is triggered;
if the second button is triggered, receiving firmware information through the first fiber interface circuit or the second fiber interface circuit; and
updating a firmware of the home controller based on the firmware information.

9. The information updating method of the home controller as claimed in claim 7, further comprising:
detecting whether a third button on the shell body of the home controller is triggered; and
enabling or disabling the first button based on whether the third button is triggered.

10. The information updating method of the home controller as claimed in claim 7, further comprising:
transmitting a control command comprising the identifier, wherein the control command serves to control the at least one home equipment.
